(19) United States
(12) Patent Application Publication
(10) Pub. No.: US 2013/0246705 A1
(43) Pub. Date: Sep. 19, 2013

(54) BALANCING LOGICAL UNITS IN STORAGE SYSTEMS

(71) Applicant: Aboubacar Diare, Antelope, CA (US)

(72) Inventor: Aboubacar Diare, Antelope, CA (US)

(21) Appl. No.: 13/421,060

(22) Filed: Mar. 15, 2012

(51) Int. Cl. G06F 12/00

(52) U.S. Cl. 711/114; 711/E12.001

(57) ABSTRACT

Techniques for generating a recommended change to balance a storage system are described in various implementations. A method that implements the techniques may include analyzing a storage system that includes a plurality of logical unit numbers (LUNs) that support asymmetric logical unit access (ALUA) to determine a current state of the storage system, wherein the current state includes LUN distribution information and system performance information. The method may also include evaluating the current state to determine whether the current state is unbalanced based on the LUN distribution information and the system performance information, and in response to determining that the current state is unbalanced, generating a recommended change to balance the storage system.

### BACKGROUND

A storage area network (SAN) is a storage architecture in which remote storage devices are virtually connected to host servers in such a way that the storage devices appear to be local to the host servers. SANs may be used, for example, to provide applications executing on the host servers with access to data stored in consolidated shared storage infrastructures.

SANs may be implemented in a number of different configurations, and may conform to various standards or protocols. For example, asymmetric logical unit access (ALUA) is a SCSI (Small Computer System Interface) standard that allows multiple controllers to route input/output (I/O) traffic (also referred to as I/O's or read/write commands) to a given logical disk in a virtualized storage system. In the virtualized storage system, the logical disks may be addressed using a SCSI protocol or other appropriate protocol. The logical disks, or logical units (LUs), are identified and addressed using logical unit numbers (LUNs).

An example of an ALUA-based storage system is a dual-controller asymmetric active-active array that is compliant with the SCSI ALUA standard for logical disk access, failover, and I/O processing. In such a storage system, two controllers are configured to provide access to a plurality of logical disks that are arranged in one or more arrays in the storage system. The controllers are typically configured to receive I/O traffic from a host server through a storage area network fabric. The host server communicates with the controllers via the controllers' respective ports. In a dual-controller system, one of the controllers is configured as a “managing controller”, which may also be referred to as the “owner” of a specific LUN. The other controller is configured as a “non-managing controller” of the LUN.

### BRIEF DESCRIPTION OF THE DRAWINGS

FIG. 1 shows a conceptual diagram of an example storage system.

FIGS. 2A-2C show conceptual diagrams of example unbalanced storage systems.

FIG. 3 shows a block diagram of example components of a storage manager.

FIG. 4 shows a flow diagram of an example process for generating a recommended change to balance a storage system.

### DETAILED DESCRIPTION

Dual-controller ALUA-based storage systems allow access from one or more host servers to any of a plurality of LUNs via either a managing controller or a non-managing controller. The storage system defines a set of target port groups for each of the LUNs—one target port group being defined for the managing controller that currently owns the LUN, and the other target port group being defined for the non-managing controller. Although the LUNs are accessible via either the managing controller or the non-managing controller, access via the non-managing controller comes with a performance penalty.

In the case of access via the managing controller, along an active/optimized path, a request from the host server is received by the managing controller, serviced by the managing controller, and acknowledged by the managing controller. In the case of access via the non-managing controller, along an active/non-optimized path, the non-managing controller receives the I/O request and sends the I/O request to the managing controller (e.g., via a backplane communication link) for servicing. The managing controller then services the I/O request, caches the resulting data, and transfers the data to the non-managing controller, which may then acknowledge the request to the host server.

When a LUN is initially created on a storage system, the LUN is associated with one of the controllers as its managing controller. In configuring the storage system, a system administrator may follow a logical plan to distribute the LUNs across the controllers in a manner that provides, or is intended to provide, a desired “balance” for the particular implementation. For example, the system administrator may follow a round-robin approach, creating new LUNs on alternating controllers so that the number of LUNs owned by one controller is similar to the number of LUNs owned by the other controller. As another example, the system administrator may estimate an expected I/O traffic level for each of the LUNs (e.g., LUNs associated with data-intensive applications may be projected to have higher I/O traffic than LUNs associated with standard applications), and may distribute the LUNs in an effort to balance the workload between the controllers.

As used here, the term “balance” is implementation-specific and depends upon the desired usage and performance characteristics of the storage system. For example, in some storage systems, balance is achieved when a similar number of LUNs are owned by each controller, while in other storage systems, balance is achieved when a similar workload is being performed by each controller, regardless of the number of LUNs that are owned by each controller. In some storage systems, a combination of the above two examples (e.g., balancing workload and the number of LUNs evenly across the controllers) may represent a desired balance in the system. These examples of balance are provided for purposes of explanation, but it should be understood that other examples of balance are also within the scope of this disclosure.

Regardless of how balance is defined in a particular implementation, storage system environments can become unbalanced in a number of different scenarios. In some cases, the storage system may be configured in an unbalanced state from the outset (e.g., upon initial misconfiguration of the system by the administrator). In other cases, even storage systems that were properly configured and balanced at a particular point in time (e.g., upon initial configuration, or following a balancing reconfiguration) may become unbalanced over time, e.g., due to various LUN transitions that may occur in the environment over time. A LUN transition causes the LUN to switch from being owned by one controller to being owned by the other controller such that the previous managing controller becomes the non-managing controller, while the previous non-managing controller becomes the managing controller for the transitioned LUN. In some cases, such LUN transitions may occur without the system administrator knowing that the transitions have occurred.

When a storage system becomes unbalanced, however balance is defined and however such imbalance may occur, it may be desirable to rebalance the environment, e.g., to improve system performance or scalability. Therefore, in accordance with the techniques described here, a storage system may continuously or periodically be monitored for such imbalances, and a possible balancing solution may be recommended when an imbalance is detected. For example, in some implementations, a storage manager may be configured to determine the current state of the storage system, evaluate the current state to determine whether the current state is unbalanced, and generate a recommended change to balance the storage system upon determining that the current state is unbalanced. Such analyses and recommended changes may be based on various system parameters or combinations of systems parameters including, for example, LUN distribution information (e.g., the number of LUNs owned by the managing and non-managing controllers, respectively), system performance information (e.g., throughput and/or latency metrics associated with the various LUNs or controllers), and/or LUN access path information (e.g., whether the LUN is being accessed through an optimal path or a non-optimal path).

The techniques described here may be used, for example, to automatically rebalance a storage environment to a desired balanced state. In some implementations, such techniques may provide for intelligent and proactive monitoring of a storage system environment to identify possible imbalances in the environment. The techniques may be used to notify a system administrator of system imbalances, potentially even before the administrator is aware of any symptoms that are associated with such imbalances. In response to detecting an unbalanced configuration, the techniques described here may be used to rebalance the storage system to a known balanced state. The techniques may also be used, in some implementations, to intelligently rebalance a storage system environment in a manner that is based on the type of imbalance that has been detected. These and other possible benefits and advantages will be apparent from the figures and from the description that follows.

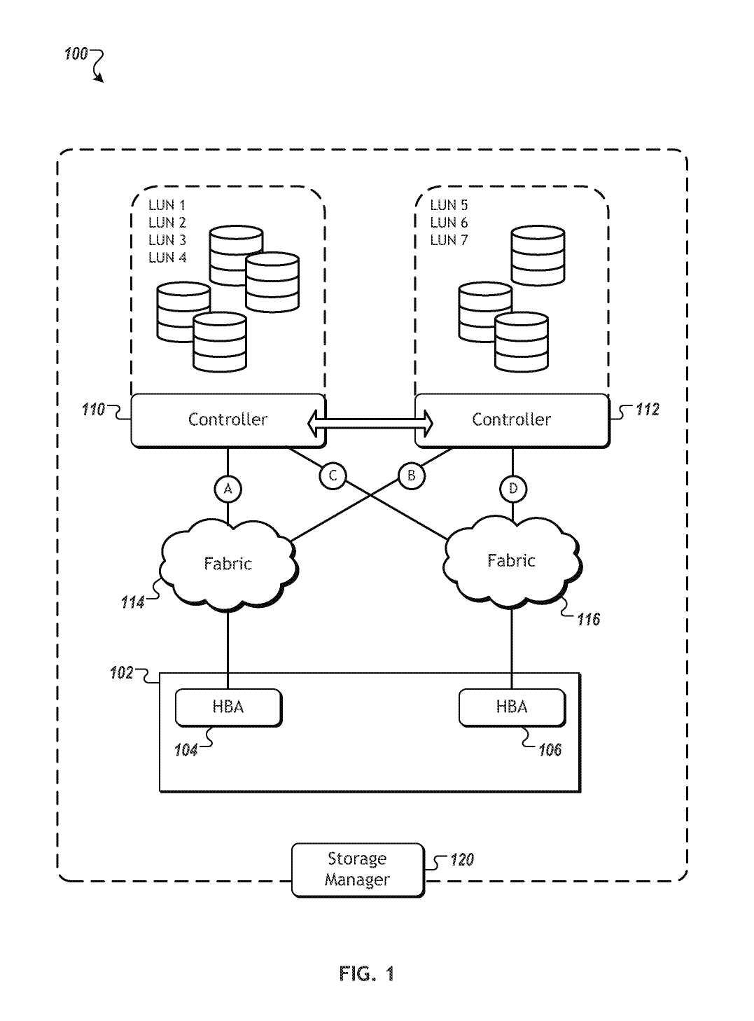

FIG. 1 shows a conceptual diagram of an example storage system 100. System 100 includes a host server 102 that is configured with multiple host bus adapters (HBAs) 104 and 106. Host server 102 may be connected to storage arrays owned by controllers 110 and 112 through a redundant fabric of network switches, or via another appropriate connection protocol. As shown, HBA 104 is communicatively coupled to controllers 110 and 112 through fabric 114, and HBA 106 is communicatively coupled to controllers 110 and 112 through fabric 116. This example topology may provide fault tolerance, with protection against the failure of a host bus adapter, a single fabric, a controller port, or a controller. However, it should be understood that the example topology is shown for illustrative purposes only, and that various modifications may be made to the configuration. For example, storage system 100 may include different or additional components, or the components may be connected in a different manner than is shown.

In the example storage system 100, controller 110 is configured as the managing controller, or owner, of logical unit numbers (LUNs) 1, 2, 3, and 4. Controller 112 is configured as the managing controller, or owner, of LUNs 5, 6, and 7. Conversely, controller 110 is the non-managing controller for LUNs 5-7, and controller 112 is the non-managing controller for LUNs 1-4. In this configuration, the active/optimized path to LUNs 1-4 is through controller 110, whether the I/O traffic originates from HBA 104 (as shown by the path labeled A) or from HBA 106 (as shown by the path labeled C). The active/optimized path to LUNs 5-7 is through controller 112, whether the I/O traffic originates from HBA 104 (as shown by the path labeled B) or from HBA 106 (as shown by the path labeled D). In this configuration, the active/non-optimized path to LUNs 1-4 is through controller 112, and the active/non-optimized path to LUNs 5-7 is through controller 110.

Storage system 100 includes a storage manager 120 that provides storage management functionality for the system. Storage manager 120 may be a computing device that includes any electronic device having functionality for processing data. Storage manager 120 may include various monitoring and provisioning features that allow a system administrator to gather information about the system, and to issue commands for controlling the system. As indicated by the dotted line, storage manager 120 may be configured to have direct or indirect access to information about the various components of storage system 100.

In some implementations, storage manager 120 may use SCSI standard commands, other standardized commands, proprietary commands, or an appropriate combination of any such commands to implement various portions of the functionality described here. According to the SCSI standard, ALUA configurations may be queried and/or managed by an application client, such as storage manager 120, using the Report Target Port Groups (RTPG) command and the Set Target Port Groups (STPG) command.

The RTPG command requests the storage array to send target port group information to the application client. The target port group information includes a preference bit (or PREF bit), which indicates whether the primary target port group is a preferred primary port group for accessing the addressed LUN. The target port group information also includes an asymmetric access state, which contains the target port group's current target port asymmetric access state (e.g., active/optimized or active/non-optimized).

The PREF bit is generally set at LUN creation time, and may be used during initial placement of the LUN. The PREF bit may also be used in some configurations to fail back a LUN that has been failed over to a non-managing controller. In a fail over/fail back configuration, LUNs that initially belong to a certain managing controller may automatically fail over to the initially non-managing controller in the event that the initial managing controller is taken offline, or is otherwise unavailable. When the initial managing controller is brought back online, the PREF bit may be used to move the LUNs that initially belonged to the initial managing controller back to the controller.

The PREF bit is independent of the target port asymmetric access state. In other words, a PREF bit for a LUN may be set for a port group associated with a controller (indicating a default preference for the port group of the particular controller), regardless of whether the controller is the owner of the LUN. As such, it is possible that a particular LUN's active/optimized access path may be changed to the other controller while the PREF bit remains set for the initial managing controller. Depending on the configuration of the system, such a discrepancy may result in undesired system performance because access to the LUN may be conducted along an active/non-optimized path.

The STPG command requests the storage array to set the primary and/or secondary target port asymmetric access states of the target ports in the specified target ports. If the set target port group descriptor specifies a primary target port asymmetric access state, the target ports in the specified target port group may transition to the specified state.

According to the techniques described here, storage manager 120 may continuously or periodically analyze the storage system 100 to determine the current state of the system. Storage manager 120 may evaluate the current state to determine whether the current state is unbalanced, and if so, may generate a recommended change (or changes) to balance the storage system. Such analyses and recommended changes may be based on various system parameters including, for example, LUN distribution information, system performance information, and/or LUN access path information. In some implementations, the recommended changes generated by storage manger 120 may be based on the type of imbalance that is detected in the system.

In the case of LUN distribution information, the storage manager 120 may query how the LUNs are distributed across the different controllers, and may determine that the system is unbalanced if too many LUNs are owned by a particular controller in relation to the other controller. In some implementations, the system administrator may define a threshold ratio of LUNs owned by one controller versus another, and if the threshold ratio is exceeded, then the system may be considered unbalanced. In such cases, the recommended change to balance the storage system may be to redistribute the LUNs in a manner that corrects the imbalance, e.g., by distributing the LUNs such that approximately half of the LUNs are owned by each controller in an approximately 50/50 distribution. Similarly, the LUNs may also be redistributed such that the distribution conforms to a defined acceptable distribution, which may be a 50/50 distribution or any other appropriate distribution as defined by a system administrator. For example, in some cases, a 60/40 distribution may be considered as an acceptably balanced distribution.

In the case of system performance information, the storage manager 120 may gather various performance metrics (e.g., throughput and/or latency statistics associated with the controllers and/or the LUNs), and may determine that the system is unbalanced if the performance information is indicative of uneven workload amongst the controllers. For example, if the storage manager 120 determines that LUNs on a particular controller are exhibiting lower throughput and/or higher latency in relation to the LUNs on the other controller, such information may be indicative of a higher workload being placed on the particular controller in relation to the other controller. In such cases, the recommended change to balance the storage system may be to redistribute the LUNs such that the workload is more evenly distributed. For example, one or more of the LUNs may be moved from the controller that is exhibiting a higher workload to the controller that is exhibiting a lower workload. As with the LUN distribution example described above, the storage manager 120 may perform such redistribution according to stored acceptable ratios of workloads amongst the controllers.

In the case of LUN access path information, the storage manager 120 may identify I/O traffic that is being routed through optimal and non-optimal paths to the various LUNs, and may determine that the system is unbalanced if the LUN access path information is indicative of inefficient input/output operation performance (e.g., when the LUNs are being accessed too frequently along non-optimal paths). In such cases, the recommended change to balance the storage system may be to update one or more preferred access paths to one or more of the LUNs that are being accessed along a non-optimal path. For example, the LUN may be moved to the other controller, or the PREF bit may be switched such that the preferred access path aligns with the managing controller.

In some cases, an appropriate combination of parameters may be collected and/or analyzed by storage manager 120 in generating the recommended change(s) to balance the storage system. For example, LUN distribution information and system performance information may be considered together to determine whether the system is unbalanced, however such imbalance is defined in the particular implementation. Similarly, in some implementations, the LUN distribution information, system performance information, and LUN access path information may all be used to determine whether an imbalance exists. In cases where a combination of parameters is used to detect an imbalance, a combination of recommended changes associated with those types of imbalances may also be used to provide an aggregated recommended change to balance the storage system.

In some implementations, storage manager 120 may also allow a system administrator to restore a previously saved system configuration. For example, upon achieving a desired balance of the storage system, a system administrator may store the configuration, and may use the stored configuration to restore balance in the event that the storage system becomes unbalanced. In some implementations, the stored configuration may include, for example, the PREF bits and LUN ownership information for each of the LUNs. If it is later determined that the current configuration differs from the stored balanced configuration, storage manager 120 may recommend restoring the stored balanced configuration by redistributing the LUNs and/or resetting the PREF bits according to the stored configuration.

These and other types of imbalances may be reported by the storage manager 120 to a user, e.g., a system administrator. For example, storage manager 120 may provide a user interface that may display any detected imbalances to the user, along with the recommended change(s) to address the particular type of imbalance exhibited in the system. The user interface may also include a mechanism, such as an input, that allows the user to apply the recommended change(s) in the event that the user agrees with the recommendation.

In some implementations, the storage manager 120 may be configured to automatically apply the recommended changes without user interaction. For example, the storage manager 120 may reference a set of implementation-specific rules that define circumstances when automatic application of the recommended change is appropriate. As one example of such a rule, a recommended change that does not involve the transition of a LUN (e.g., only switching a PREF bit) may be automatically applied because such a change may have a low risk of affecting system performance. As another example rule, a recommended change that involves transition of a LUN that is currently inactive, and that is projected to be inactive for a period of time, may be applied automatically without any user interaction. These and other rules may be defined on an implementation-specific basis, and may allow automatic rebalancing of a storage system, e.g., in a manner that has relatively minimal impact on the performance of the system.

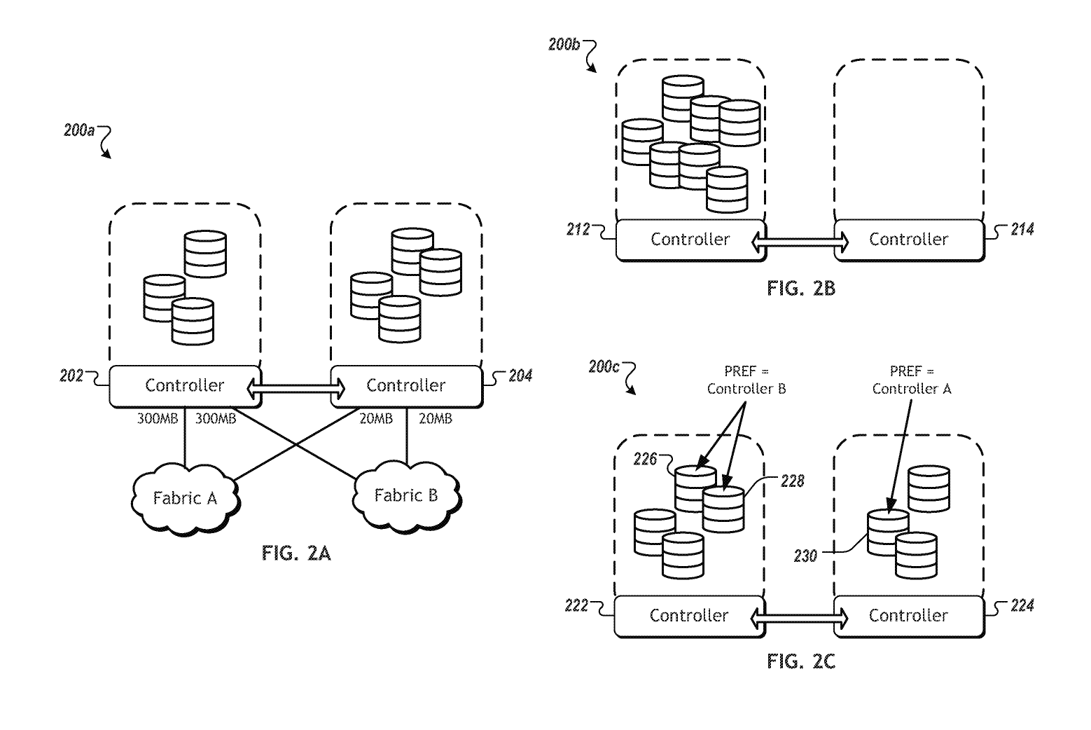

FIGS. 2A-2C show conceptual diagrams of example unbalanced storage systems 200a, 200b, and 200c. These examples are for purposes of explanation only, and it should be understood that other examples or types of imbalance are also within the scope of this disclosure.

In FIG. 2A, the LUNs are relatively evenly distributed amongst the two controllers, with controller 202 owning three LUNs and controller 204 owning four LUNs. However, in this example, a majority of the I/O traffic is being serviced by controller 202, while controller 204 is relatively underutilized. This situation may occur, for example, if the LUNs associated with heavily-used application are owned by one controller, while LUNs that are associated with less-used applications are owned by the other controller. In this scenario, controller 202 may exhibit slower throughput and/or higher latency than controller 204 due to the discrepancy in workload between the two controllers.

In such a scenario, the system may be more evenly balanced by estimating the workload associated with the various LUNs and recommending a reconfiguration that moves one or more of the LUNs to a different controller such that the workload is distributed more evenly across the controllers. For example, in this case, if one of the LUNs owned by controller 202 is responsible for approximately 140 MB of I/O traffic, a recommended change may be to move that LUN to controller 204, which may result in both controllers having a workload of approximately 160 MB of I/O traffic.

In some cases, only balancing the workload may skew the distribution balance. For example, as described above, if one of the LUNs from controller 202 is moved to controller 204, then controller 202 will own two LUNs, while controller 204 will own five LUNs. In some cases, such an unbalanced LUN distribution may be acceptable so long as the workload is balanced. However, in other cases, the system may only be considered balanced if both the workload and the distribution are balanced. In such cases, the recommended change may be to also move one or more of the LUNs owned by controller 204 to controller 202 such that both the distribution and the workload are balanced among the two controllers.

In FIG. 2B, all of the LUNs are owned by a single controller (controller 212), while the other controller (controller 214) remains relatively idle as the non-managing controller for all of the LUNs. One scenario under which this may occur is if the environment is configured such that failed-over LUNs are not automatically failed-back to their previous owner. In this scenario, when a managing controller fails or is otherwise taken offline, the LUNs may automatically be migrated to the other controller. When the previous managing controller is later brought back online, the LUNs may not automatically be failed back to the previous managing controller. As such, all of the LUNs may be owned by a single controller, which creates an unbalanced environment, both in terms of workload and LUN distribution. As described above, the recommended change in such a scenario may be to evenly distribute the LUNs and/or the workload across the two controllers.

In FIG. 2C, some of the LUNs have been transitioned to a non-preferred default controller. In the example, LUNs 226 and 228 are currently owned by controller 222, so the I/O traffic may be preferentially conducted on the active/optimized path through controller 222. However, the PREF bits for LUNs 226 and 228, respectively, are set to controller 224. Similarly, LUN 230 is currently owned by controller 224, so the I/O traffic is preferentially being conducted on the active/optimized path through controller 224, but the PREF bit for LUN 230 is set to controller 222. Such misalignment of the default preferred controller and the active/optimized path to a given LUN may cause performance degradation either in the short term (e.g., in systems where the PREF bit is used to control the access path for I/O traffic), or in the event that the misalignment causes the system to become unbalanced due to later LUN transitions based on the PREF bit.

In such a scenario, a recommended change to balance the system may include transitioning the LUNs having misaligned preferred controllers and asymmetric access states, or changing the PREF bit for the LUNs. In some implementations, it may be preferred to change the PREF bit for the LUNs rather than transitioning the LUNs, e.g., to minimize the impact on the storage system. However, as described above, the storage system may also be exhibiting other imbalances or types of imbalances, and the storage manager may be configured to consider multiple system parameters to determine a recommended approach for balancing the storage system that may include transitioning the LUNs, changing PREF bits, or both.

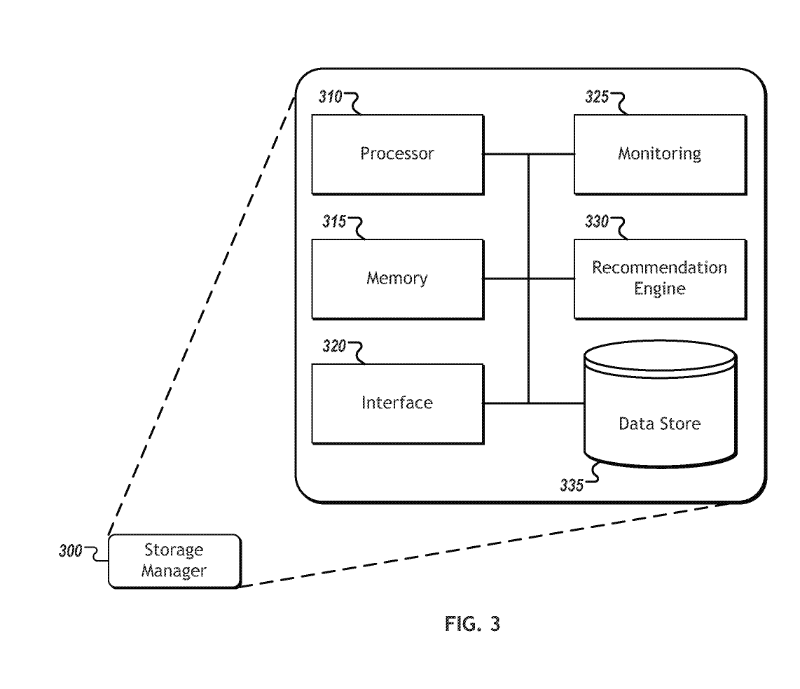

FIG. 3 shows a block diagram of example components of a storage manager 300. Storage manager 300 may perform portions of, all of, or functionality similar to that of storage manager 120 shown in FIG. 1. In some implementations, storage manager 300 may provide storage management functionality for a storage system, including various monitoring and provisioning features.

As shown, storage manager 300 may include a processor 310, a memory 315, an interface 320, a monitoring module 325, a recommendation engine 330, and data store 335. It should be understood that these components are shown for illustrative purposes only, and that in some cases, the functionality being described with respect to a particular component may be performed by one or more different or additional components. Similarly, it should be understood that portions or all of the functionality may be combined into fewer components than are shown.

Processor 310 may be configured to process instructions for execution by the storage manager 300. The instructions may be stored on a non-transitory tangible computer-readable storage medium, such as in main memory 315, on a separate storage device (not shown), or on any other type of volatile or non-volatile memory that stores instructions to cause a programmable processor to perform the functionality described herein. Alternatively or additionally, storage manager 300 may include dedicated hardware, such as one or more integrated circuits, Application Specific Integrated Circuits (ASICs), Application Specific Special Processors (ASSPs), Field Programmable Gate Arrays (FPGAs), or any combination of the foregoing examples of dedicated hardware, for performing the functionality described herein. In some implementations, multiple processors may be used, as appropriate, along with multiple memories and/or different or similar types of memory.

Interface 320 may be used to issue and receive various commands associated with storage management. For example, interface 320 may be configured to issue SCSI standard commands, such as Report Target Port Groups and Set Target Port Groups, that allow storage manager 300 to gather information about the storage system configuration, and to issue commands for controlling the system.

Interface 320 may also provide a user interface for interaction with a user, such as a system administrator. For example, the user interface may be used to display detected imbalances to a user, and may also provide a mechanism for the user to apply any recommended changes to the system. In some implementations, storage manager 300 may be used to provide multiple recommendations to balance the system, ranked in accordance with the expected or potential impact of the changes to the system. Interface 320 may display the multiple recommendations to a user, and may cause one or more of the recommendations to be applied based on a selection by the user. In some implementations, interface 320 may also be configured to apply a recommended change automatically, e.g., without user interaction.

Monitoring module 325 may execute on processor 310, and may be configured to monitor various system parameters associated with the storage system. Monitoring module 325 may execute continuously or periodically to gather information that may be used by recommendation engine 330, and may store the gathered information in memory 315, in data store 335, or in a separate storage device.

In some implementations, monitoring module 325 may collect LUN distribution information that corresponds to how the various LUNs in the storage system are distributed amongst the controllers of the storage system, e.g., by issuing Report Target Port Groups commands to the various LUNs and storing the responses. Monitoring module 325 may also or alternatively collect system performance information that corresponds to at least one performance metric associated with the LUNs or the controllers. For example, monitoring module 325 may collect I/O traffic data, including a measure of the rate of the I/O traffic to or from the LUNs (e.g., in MBPS or IOPS). As another example, monitoring module 325 may collect latency data associated with access times to the various LUNs. Monitoring module 325 may also or alternatively collect LUN access path information that corresponds to paths through which the LUNs are being accessed.

Recommendation engine 330 may execute on processor 310, and may be configured to detect imbalances in the storage system based on the various system parameters collected by monitoring module 325. For example, recommendation engine 330 may compare the current state of the storage system to predetermined parameters and rules that define whether the system is balanced. If the current state of the storage system does not fit within the definition of a balanced system, then the system may be considered to be unbalanced. The predetermined rules and parameters may be user-configurable, e.g., by a system administrator, and may be specific to a particular implementation. Such predetermined rules and parameters may be defined in one or more balancing policies, which may be stored, e.g., in data store 335.

If system imbalances are detected, recommendation engine 330 may also be configured to determine a recommended change (or changes) to balance the storage system. Recommendation engine 330 may consider one or more of the various system parameters to determine a recommended approach for balancing the system. The recommended changes may be based on the type of imbalance detected by the engine.

For example, when the system performance information is indicative of uneven workload amongst the plurality of controllers (e.g., greater than 75% of the processing being conducted by one of the controllers), the recommended change may be to redistribute one or more of the LUNs such that the workload is more evenly distributed (e.g., 50/50; 60/40; 65/35; etc.). As another example, when the LUN distribution information is indicative of an undesired distribution of the plurality of LUNs, the recommended change may be to redistribute one or more of the LUNs such that the distribution of the LUNs conforms to a defined acceptable distribution (e.g., 50/50; 60/40; 65/35; etc.). As another example, when the LUN access path information is indicative of inefficient I/O performance, the recommended change may be to update one or more preferred access paths to one or more of the LUNs. In some implementations, multiple imbalances and/or types of imbalances may be detected, and the recommended change may be to rebalance the system in a manner that addresses the multiple imbalances and/or types of imbalances.

In some implementations, recommendation engine 330 may be used to restore a previously saved storage configuration. For example, upon achieving a desired balance of the storage system, a system administrator may store the balanced configuration, e.g., as a configuration file, or in data store 335. The stored balanced configuration may include, for example, the PREF bits and LUN ownership information for each of the LUNs in the storage system. If it is later determined that the current configuration differs from the stored balanced configuration, recommendation engine 330 may recommend restoring the stored balanced configuration by redistributing the LUNs and/or resetting the PREF bits according to the stored configuration.

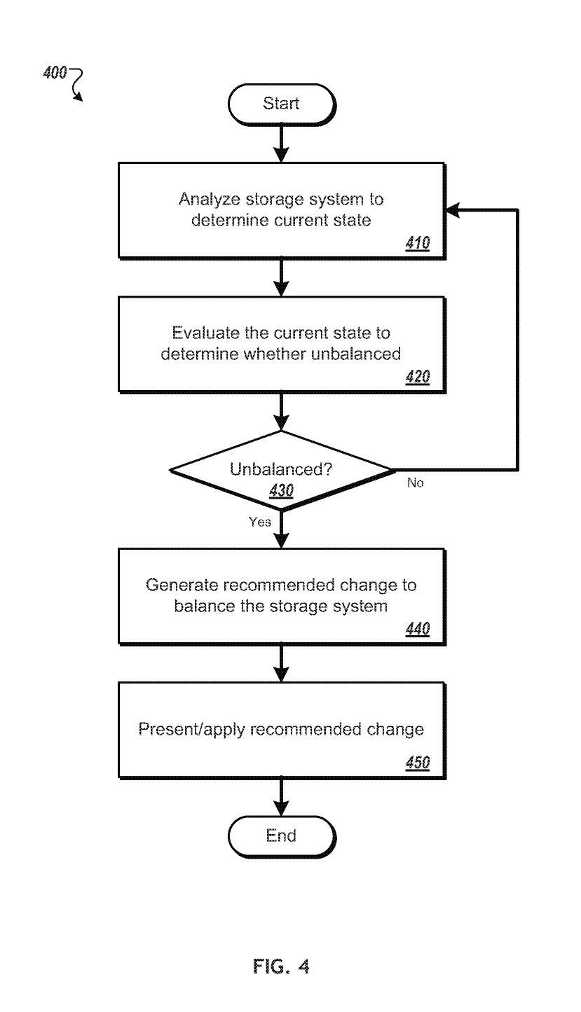

FIG. 4 shows a flow diagram of an example process 400 for generating a recommended change to balance a storage system. The process 400 may be performed, for example, by a storage management component such as the storage manager 120 illustrated in FIG. 1. For clarity of presentation, the description that follows uses the storage manager 120 illustrated in FIG. 1 as the basis of an example for describing the process. However, it should be understood that another system, or combination of systems, may be used to perform the process or various portions of the process.

Process 400 begins at block 410, in which a storage system is analyzed to determine the current state of the storage system. For example, a monitoring module of storage manager 120 may be configured to continuously or periodically gather various system parameters that relate to how the system is configured and/or how the system is performing.

In some implementations, the current state of the storage system may include LUN distribution information that corresponds to how the various LUNs are distributed amongst the controllers. The current state of the storage system may also or alternatively include system performance information that corresponds to at least one performance metric associated with the LUNs (e.g., latency, throughput, etc.). The current state of the storage system may also or alternatively include LUN access path information that corresponds to paths through which the LUNs are accessed. The current state of the storage system may also or alternatively include other appropriate parameters that relate to whether the system is balanced, however such balance is defined for a particular implementation.

At block 420, the current state of the storage system is evaluated to determine whether the system is unbalanced. For example, a recommendation engine may compare the current state of the storage system to various parameters and rules that define whether the system is balanced in a particular implementation. Such evaluation may be based on the various parameters described above, including for example, LUN distribution information, system performance information, and/or LUN access path information.

At decision block 430, if the storage system is not determined to be unbalanced, process 400 returns to block 410. If the storage system is determined to be unbalanced, process 400 continues to block 440, where a recommended change to balance the storage system is generated. The recommendation engine may consider one or more of the various system parameters, or a combination of the parameters, to determine a recommended approach for balancing the system.

For example, when the current state differs from a stored balanced configuration, the recommended change may be to redistribute one or more of the LUNs according to the stored balanced configuration. As another example, when the system performance information is indicative of uneven workload amongst the plurality of controllers, the recommended change may be to redistribute one or more of the LUNs such that the workload is more evenly distributed (e.g., 50/50; 60/40; 65/35; etc.). As another example, when the LUN distribution information is indicative of an undesired distribution of the plurality of LUNs, the recommended change may be to redistribute one or more of the LUNs such that the distribution of the LUNs conforms to a defined acceptable distribution (e.g., 50/50; 60/40; 65/35; etc.). As another example, when the LUN access path information is indicative of inefficient I/O performance, the recommended change may be to update one or more preferred access paths to one or more of the LUNs. In some implementations, multiple imbalances and/or types of imbalances may be detected, and the recommended change may be to rebalance the system in a manner that addresses the multiple imbalances and/or types of imbalances.

At block 450, the recommended change is presented or automatically applied to balance the storage system. For example, the recommended change may be presented on a user interface that includes a mechanism that allows a user, e.g., a system administrator, to apply the recommended change. As another example, the recommended change may be applied without user interaction, e.g., in the case that the recommended change meets predetermined criteria defined by a system administrator.

Although a few implementations have been described in detail above, other modifications are possible. For example, the logic flows depicted in the figures may not require the particular order shown, or sequential order, to achieve desirable results. In addition, other steps may be provided, or steps may be eliminated, from the described flows. Similarly, other components may be added to, or removed from, the described systems. Accordingly, other implementations are within the scope of the following claims.

What is claimed is:

1. A computer-implemented method comprising:
analyzing, using a computing device, a storage system that includes a plurality of logical unit numbers (LUNs) that support asymmetric logical unit access (ALUA) to determine a current state of the storage system, wherein the current state includes LUN distribution information that corresponds to how the plurality of LUNs are distributed amongst a plurality of controllers and system performance information that corresponds to at least one performance metric associated with the plurality of LUNs;
evaluating the current state, using the computing device, to determine whether the current state is unbalanced based on the LUN distribution information and the system performance information; and
in response to determining that the current state is unbalanced, generating, using the computing device, a recommended change to balance the storage system.

2. The computer-implemented method of claim 1, wherein the current state differs from a stored balanced configuration, and wherein the recommended change to balance the storage system includes redistributing the plurality of LUNs according to the stored balanced configuration.

3. The computer-implemented method of claim 1, wherein the system performance information is indicative of uneven workload amongst the plurality of controllers, and wherein the recommended change to balance the storage system includes redistributing the plurality of LUNs such that the workload is more evenly distributed.

4. The computer-implemented method of claim 1, wherein the LUN distribution information is indicative of an undesired distribution of the plurality of LUNs, and wherein the recommended change to balance the storage system includes redistributing the plurality of LUNs such that the distribution of the plurality of LUNs conforms to a defined acceptable distribution.

5. The computer-implemented method of claim 1, wherein the current state of the storage system further includes LUN access path information that corresponds to paths through which the plurality of LUNs are accessed, and wherein evaluating the current state to determine whether the current state is unbalanced is further based on the LUN access path information.

6. The computer-implemented method of claim 5, wherein the LUN access path information is indicative of inefficient input/output operation performance, and wherein the recommended change to balance the storage system includes updating at least one preferred access path to at least one of the plurality of LUNs.

7. The computer-implemented method of claim 1, further comprising presenting the recommended change on a user interface that includes a mechanism to allow a user to apply the recommended change.

8. The computer-implemented method of claim 1, further comprising applying the recommended change without user interaction.

9. A system comprising:
a processor;
a monitoring module, executing on the processor, to monitor a storage system to collect logical unit number (LUN) distribution information that corresponds to how a plurality of LUNs are distributed amongst a plurality of controllers in the storage system and system performance information that corresponds to at least one performance metric associated with the plurality of LUNs;
a memory to store the LUN distribution information and the system performance information; and
a recommendation engine, executing on the processor, to determine a recommended change to balance the storage system based on the LUN distribution information and the system performance information.

10. The system of claim 9, further comprising an interface to present the recommended change to balance the storage system, and to provide a mechanism that allows a user to apply the recommended change.

11. The system of claim 9, further comprising an interface to apply the recommended change without user interaction.

12. The system of claim 9, wherein the monitoring module further collects LUN access path information that corresponds to paths through which the plurality of LUNs are accessed, and wherein the recommendation engine determines the recommended change to balance the storage system further based on the LUN access path information.

13. The system of claim 9, wherein the recommended change to balance the storage system includes redistributing the plurality of LUNs according to a stored balanced configuration.

14. A non-transitory computer-readable storage medium storing instructions that, when executed by a processor, cause the processor to:
determine a current state of a storage system that includes a plurality of logical unit numbers (LUNs) that are accessed through a plurality of controllers, wherein the current state includes system performance information that corresponds to at least one performance metric associated with the plurality of LUNs;
evaluate the current state to determine whether the current state is unbalanced based on the system performance information; and
determine a recommended change to balance the storage system in response to determining that the current state is unbalanced.

15. The non-transitory computer-readable storage medium of claim 14, wherein the current state further includes LUN distribution information that corresponds to how the plurality of LUNs are distributed amongst the plurality of controllers, and wherein determining whether the current state is unbalanced is further based on the LUN distribution information.
